(19) United States
(12) Patent Application Publication
(10) Pub. No.: US 2026/0267249 A1
(43) Pub. Date: Sep. 10, 2026

(54) POSITIVELY CHARGEABLE TONER PARTICLES, TONER COMPOSITIONS, AND METHODS FOR PRODUCTION THEREOF

(71) Applicant: XEROX CORPORATION, Norwalk, CT (US)

(72) Inventors: Jing X. SUN, Lexington, KY (US); Elizabeth K. PRIEBE, Rochester, NY (US); Chieh-Min CHENG, Rochester, NY (US)

(73) Assignee: XEROX CORPORATION, Norwalk, CT (US)

(21) Appl. No.: 19/070,222

(22) Filed: Mar. 4, 2025

(51) Int. Cl. G03G 9/093; G03G 9/097

(52) U.S. Cl. CPC G03G 9/09392; G03G 9/09328; G03G 9/09335; G03G 9/09371; G03G 9/09741; G03G 9/0975; G03G 9/09775

(57) ABSTRACT

Toner particles and toner compositions may be formed using a charge control agent that promotes positive triboelectric chargeability. Toner compositions may comprise: toner particles comprising a polymer bearing a plurality of negatively charged functional groups and at least one charge control agent blended within the polymer. The at least one charge control agent comprises a cationic portion and an anionic portion, and the cationic portion forms an ionic association with at least a portion of the negatively charged functional groups to reduce an overall negative charge of the polymer. The at least one charge control agent is present in at least one location within the toner particles. The toner particles and toner compositions may exhibit positive triboelectric chargeability.

### FIELD

The present disclosure generally relates to printing and, more specifically, to positively chargeable toner particles, toner compositions, and methods for production thereof.

### BACKGROUND

In electrophotographic printing, an electrostatic image is latently formed by selectively discharging areas of a photoconductive drum. Toner particles that are triboelectrically charged then adhere to the electrostatic image through electrostatic attractions to produce a visible image. The visible image is then transferred from the photoconductive drum to a substrate such as paper. After transfer, the visible image is then fused to the paper by heating, during which the toner particles melt and bond with the substrate.

Toner particles, depending on their composition, may have a positive or negative charge when charged triboelectrically. Most commercial chemically prepared toner (CPT) compositions are produced by emulsion aggregation (EA) methods and are negatively chargeable due to their use of anionic polymers. Most commercial toners are negatively chargeable due to their reliance on established manufacturing processes and cartridge designs. Anionic polyester resins are commonly used in the production of negatively chargeable toners.

There is a growing demand for positively chargeable toner compositions, especially chemically prepared toner compositions, which may provide advantages in terms of particle size, particle shape, particle size distribution, and particle shape distribution, which may facilitate high-speed printing and good printing quality. This performance benefit is at least in part due to the durability, low-energy fusing, charge-up speed, charge value, and stability of positively chargeable toner compositions.

Despite their potential benefits, positively chargeable toner compositions may be difficult to manufacture through chemical production. One approach for producing positively chargeable toner compositions is to begin with different starting materials than those used to produce negatively chargeable toner compositions. This approach can be cost-prohibitive because of the different starting materials and potentially different production methods. For example, positively charged (cationic) polymers may fail to emulsify in the same manner as negatively charged polymers. Currently available positively chargeable CPTs are commonly formulated using styrene-acrylic resins, which often exhibit poorer printing performance compared to polyester resins, such as poorer charge-up speed, substrate fusion, stability, and glossiness, as well as higher fusion temperatures.

### SUMMARY

In some embodiments, the present disclosure provides methods comprising: providing a polymer bearing a plurality of negatively charged functional groups, and at least one charge control agent is blended within the polymer; wherein the at least one charge control agent comprises a cationic portion and an anionic portion, the cationic portion forming an ionic association with at least a portion of the negatively charged functional groups and reducing an overall negative charge of the polymer; removing at least a portion of the anionic portion from the polymer; and processing the polymer to form toner particles. The at least one charge control agent is present in at least one location within the toner particles.

In some or other embodiments, the present disclosure provides toner compositions, comprising: toner particles comprising a polymer bearing a plurality of negatively charged functional groups; and at least one charge control agent blended within the polymer. The at least one charge control agent comprises a cationic portion and an anionic portion. The cationic portion forms an ionic association with at least a portion of the negatively charged functional groups and reduces an overall negative charge of the polymer. The at least one charge control agent is present in at least one location within the toner particles.

### BRIEF DESCRIPTION OF THE DRAWINGS

Not applicable.

### DETAILED DESCRIPTION

The present disclosure generally relates to printing and, more specifically, to positively chargeable toner particles, toner compositions, and methods for production thereof.

As discussed above, most commercial toner compositions produced by emulsion aggregation (EA) methods are negatively chargeable toners, which frequently contain anionic polyester resins. Toner particles produced though emulsion aggregation methods may be referred to as “EA toners” or “EA toner compositions” herein. Although there is growing demand for positively chargeable toners, comparable production of positively chargeable toners by emulsion aggregation has proven difficult. For example, direct use of cationic polymers instead of anionic polymers during EA toner methods may disrupt the facile particle aggregation and coalescence processes that are characteristic of negatively chargeable toners. Without being bound by theory or mechanism, additional components used in toner production, such as wax and pigment dispersions, are stabilized with negative surfactants, which may be ineffective for emulsifying cationic polymers and may also contribute to negative chargeability.

The present disclosure provides positively chargeable toner particles and toner compositions and facile production methods thereof. More specifically, the present disclosure leverages current emulsion aggregation methods for producing negatively chargeable toner particles and toner compositions but adds a positively chargeable charge control agent and other additives to shift the overall particle chargeability from negative to positive. This approach may allow equipment, starting materials, and production methods used for producing negatively chargeable toners to be adapted for producing positively chargeable toners. Producing positively chargeable toner particles and toner compositions in this manner may allow for reduced costs compared to preparing positively chargeable toners from scratch with different starting materials and production methods. Surprisingly, altering the chargeability state of toner particles from negative to positive does not appreciably disrupt the EA processes utilized during toner production. At the least, the amount of charge control agent may be adjusted to achieve sufficient positive chargeability without disrupting the EA process to a significant degree.

In the present disclosure, “chargeable” refers to triboelectric chargeability, which occurs through static electricity charging. When referring to toner particles or toner compositions formed therefrom, triboelectric chargeability refers to the ability of the toner particles to obtain a charge when charged triboelectrically with static electricity and maintain the charge consistently during a printing process, during which the toner particles transfer and adhere to a print substrate under electrostatic forces. The terms “chargeable” and “chargeability” do not necessarily refer to the absolute charge of the toner particles or a polymer therein before triboelectric charging.

The present disclosure seeks to decrease the amount of negative charge in the toner particles through use of a suitable charge control agent that allows a positive charge to be realized during triboelectric charging. Without being bound by theory, anionic functional groups of the anionic polymer within the toner particles may associate with the cationic portion of the charge control agent to neutralize at least a portion of the initial negative charge of the anionic polymer. All of the anionic functional groups in the anionic polymer need not necessarily have their negative charge neutralized by the cationic portion of the charge control agent. Thus, positively chargeable toner particles may still have an overall negative charge by virtue of an incompletely neutralized anionic polymer before triboelectric charging.

Glass transition temperature (T_{g}) is the temperature at which a polymer changes from a rigid state to a soft state. In the present disclosure, the glass transition temperature (T_{g}) may be determined by differential scanning calorimetry over a temperature range of 0° C. to 140° C. with a 10° C./minute ramping rate.

In the present disclosure, the term “D50” refers to a diameter at which 50% of a sample (on a volume basis unless otherwise specified) is comprised of particles having a diameter less than said diameter value. D50 represents the average particle size by volume. In the present disclosure, the term “D10” refers to a diameter at which 10% of a sample (on a volume basis unless otherwise specified) is comprised of particles having a diameter less than said diameter value. In the present disclosure, the term “D90” refers to a diameter at which 90% of a sample (on a volume basis unless otherwise specified) is comprised of particles having a diameter less than said diameter value. Particle size may be measured using a Beckman Coulter Multisizer 3, operated in accordance with the manufacturer's instructions.

In the present disclosure, the terms “diameter span,” “span” and “span size,” when referring to a particle diameter, provides an indication of the breadth of the particle size distribution and is calculated as (D90-D10)/D50, as these quantities are defined above. The narrower the particle size distribution, the closer the span is to a value of 1.

In the present disclosure, the term “circularity” refers to how close a toner particle is to a perfect sphere. To determine circularity, optical microscopy images are taken of a toner particle. The perimeter and area of the particle in the plane of the microscopy image is calculated (e.g., using a SYSMEX FPIA 3000 particle shape and particle size analyzer, available from Malvern Instruments). The circularity of the toner particle is CEA/P, where CEA is the circumference of a circle having the area equivalent to the area of the cross-section of the actual particle in the plane of the microscopy image, and P is the perimeter of the cross-section of the actual particle in the plane of the microscopy image. The more spherical the toner particles are, the closer the circularity is to a value of 1. Toner compositions of the present disclosure may comprise: toner particles comprising

a polymer bearing a plurality of negatively charged functional groups, and at least one charge control agent blended within the polymer. The at least one charge control agent comprises a cationic portion and an anionic portion, in which the cationic portion forms an ionic association with at least a portion of the negatively charged functional groups and reduces an overall negative charge of the polymer. The at least one charge control agent is present in at least one location within the toner particles. Overall, the toner particles and toner compositions resulting therefrom may be positively chargeable, as assessed by triboelectric chargeability.

Accordingly, the at least one charge control agent may neutralize at least a portion of the negative charge within the toner particles and toner compositions obtained therefrom. In doing so, the at least one charge control agent may be located throughout the toner particles, or the at least one charge control agent may be absent from one or more portions of the toner particles, as described hereinafter.

Suitable polymers for forming the toner particles may include, but are not limited to polyacrylates, polyesters, polystyrenes, any copolymer thereof, and any combination thereof. Suitable polyesters may be linear, branched, or combinations thereof. Illustrative polyesters that may be suitable include those described in U.S. Pat. Nos. 11,092,906 and 8,383,311, the disclosures of which are incorporated by reference in their entirety. In some embodiments, the polymer may comprise an anionic polyester.

The toner particles may comprise one or more anionic polymers, which may be linear, branched, or any combination thereof. The one or more anionic polymers may comprise a plurality of negatively charged functional groups, including, but not limited to, carboxylates or sulfonates. The negatively charged functional groups may be present within the main polymer chain or be present within a side chain of the anionic polymer. Optionally, a co-monomer bearing the anionic functional groups may be reacted with one or more other monomers that are otherwise uncharged.

Optionally, additional anionic functional groups may be introduced through carboxylation or sulfonation of an otherwise unfunctionalized polymer. Illustrative anionic polymers that may be suitable for use in the present disclosure include, but are not limited to, anionic polyesters. Examples of polyester-based toners that may be modified according to the disclosure herein include those described in U.S. Pat. Nos. 11,092,906 and 8,383,311, the disclosures of which are incorporated by reference above.

Suitable anionic polyesters for inclusion in the toner particles may include amorphous polyesters, crystalline polyesters, or any combination thereof. In some examples, an anionic polyester may be present in combination with another polymer, such as a styrene-acrylate.

When amorphous polyesters and crystalline polyesters are used in combination with one another, the amorphous polyester and the crystalline polyester may be present over a wide composition range. In non-limiting examples, the ratio of crystalline polyester to amorphous polyester may range from about 1:99 to about 99:1 on a mass basis or about 1:9 to about 9:1 on a mass basis. For example, the amorphous polyester may range from about 60 wt % to about 80 wt %, based on total polymer in the toner particles, and the crystalline polyester may range from about 20 wt % to about 40 wt %, based on total polymer in the toner particles. A single amorphous polyester or multiple amorphous polyesters may be present. Likewise, a single crystalline polyester or multiple crystalline polyesters may be present.

Polyesters may be formed as a polymerized reaction product of a diol and a dicarboxylic acid or dicarboxylic acid derivative (e.g., an ester of a dicarboxylic, an anhydride of a dicarboxylic acid, or a diacid chloride). Depending on whether an amorphous polyester or a crystalline polyester is desired, the diol and the dicarboxylic acid or dicarboxylic acid derivative may be selected accordingly.

Examples of diacids or diesters suitable for forming amorphous polyesters may include, but are not limited to, terephthalic acid, phthalic acid, isophthalic acid, fumaric acid, trimellitic acid, dimethyl fumarate, dimethyl itaconate, cis-1,4-diacetoxy-2-butene, diethyl fumarate, diethyl maleate, maleic acid, succinic acid, itaconic acid, succinic anhydride, dodecylsuccinic acid, dodecenylsuccinic acid, dodecylsuccinic anhydride, dodecenylsuccinic anhydride, glutaric acid, glutaric anhydride, adipic acid, pimelic acid, suberic acid, azelaic acid, dodecanediacid, dimethyl terephthalate, diethyl terephthalate, dimethylisophthalate, diethylisophthalate, dimethylphthalate, phthalic anhydride, diethylphthalate, dimethylsuccinate, dimethylfumarate, dimethylmaleate, dimethylglutarate, dimethyladipate, dimethyl dodecylsuccinate, and any combination thereof. Anhydrides of any of the foregoing carboxylic acids may also be used.

Examples of diols suitable for forming amorphous polyesters may include, but are not limited to, 1,2-propanediol, 1,3-propanediol, 1,2-butanediol, 1,3-butanediol, 1,4-butanediol, pentanediol, hexanediol, 2,2-dimethylpropanediol, 2,2,3-trimethylhexanediol, heptanediol, dodecanediol, bis(hydroxyethyl)-bisphenol A, bis(2-hydroxypropyl)-bisphenol A, propoxylated bisphenol A, ethoxylated bisphenol A, 1,4-cyclohexanedimethanol, 1,3-cyclohexanedimethanol, xylenedimethanol, cyclohexanediol, diethylene glycol, bis(2-hydroxyethyl) oxide, dipropylene glycol, dibutylene glycol, and any combination thereof.

In some examples a suitable amorphous polyester may comprise poly(propoxylated bisphenol A-co-fumarate), such as that described in U.S. Pat. No. 6,063,827, which is incorporated herein by reference. Other examples of suitable amorphous polyesters may include, for instance, a copolymerized reaction product of propoxylated bisphenol A, ethoxylated bisphenol A, terephthalic acid, fumaric acid, and dodecenyl succinic anhydride (e.g., poly(propoxylated (ethoxylated)bisphenol A-co-terephthlate-fumarate-dodecenylsuccinate) or a copolymerized reaction product of propoxylated bisphenol A, ethoxylated bisphenol A, terephthalic acid, trimellitic acid, and dodecenyl succinic anhydride.

Examples of diacids or diesters suitable for forming crystalline polyesters may include, but are not limited to, oxalic acid, succinic acid, glutaric acid, adipic acid, suberic acid, azelaic acid, sebacic acid, fumaric acid, dimethyl fumarate, dimethyl itaconate, cis-1,4-diacetoxy-2-butene, diethyl fumarate, diethyl maleate, phthalic acid, isophthalic acid, terephthalic acid, naphthalene-2,6-dicarboxylic acid, naphthalene-2,7-dicarboxylic acid, cyclohexane dicarboxylic acid, malonic acid, and mesaconic acid. Anhydrides of any of the foregoing carboxylic acids may also be used.

Examples of diols suitable for forming crystalline polyesters may include, but are not limited to, C₂ to C₃₆ diols, preferably terminal diols, such as 1,2-ethanediol, 1,3-propanediol, 1,4-butanediol, 1,5-pentanediol, 2,2-dimethylpropane-1,3-diol, 1,6-hexanediol, 1,7-heptanediol, 1,8-octanediol, 1,9-nonanediol, 1,10-decanediol, 1,12-dodecanediol, or any combination thereof.

In some examples a suitable crystalline polyester may comprise a polymerized reaction product of dodecanedioic acid and 1,9-nonanediol.

The at least one charge control agent may be present within the polymer and toner particles obtained therefrom in an amount ranging from about 0.01 wt % to about 5 wt %, or about 0.1 wt % to about 3 wt %, or about 0.5 wt % to about 2.5 wt %, or about 0.5 wt % to about 2 wt %, or about 0.5 wt % to about 1 wt %, including all values and subranges in between, based on total mass of the polymer. The measured amount of the at least one charge control agent refers to the measured amount of the cationic portion of the at least one charge control agent that remains after isolation of the toner particles has taken place.

Any charge control agent that is positively chargeable and does not interfere with the processes for making the toner particles may be utilized in the disclosure herein. Preferably, the at least one charge control agent may comprise a quaternary ammonium salt. In some examples, such charge control agents may comprise a quaternary ammonium cation and a sulfonate anion. Quaternary ammonium hydroxynaphthalene sulfonates may be particularly suitable charge control agents, for example. In more specific examples, the at least one charge control agent may comprise benzyltributylammonium hydroxynaphthalenesulfonate, which is available commercially as BONTRON-P51 (Orient Corporation). The relatively high water solubility of the sulfonate anion may allow the sulfonate anion to be readily removed by washing once the quaternary ammonium cation has become associated with an anionic functional group of the anionic polymer or other negative charged component (e.g., an anionic surfactant) within a toner composition.

Other non-limiting examples of suitable positively chargeable charge control agents may include, for example, distearyldimethyl ammonium methyl sulfate, distearyl dimethyl ammonium bisulfate. 4-aza-1-azoniabicyclo(2.2.2) octane salts, pyridinium salts, azines such as BONTRON N-series charge control agents or NIGROSINE charge control agents (Orient Corporation), polyamines, imidazoles, pyridines, and the like.

The cationic portion of the charge control agent may form an ionic association with the anionic functional groups of the anionic polymer or other component, thereby reducing an overall negative charge upon the polymer. After interacting with the charge control agent, the anionic polymer and toner particles obtained therefrom may be positively chargeable when charged triboelectrically. The overall triboelectric charge may be further shifted to positive using positively charged internal or external additives such as, for example, positively charged surfactants, positively charged metal oxides, and charge additives, illustrative examples of which are provided hereinbelow.

The toner particles may comprise core-shell toner particles. Core-shell toner particles may comprise a core surrounded by a shell, wherein the core and the shell may comprise the same anionic polymer(s) or different anionic polymer(s). In some examples, the core and the shell may comprise the same anionic polymer. The core and the shell may comprise a crystalline polyester or an amorphous polyester. Optionally, the core and/or the shell may comprise the combination of a crystalline polyester and an amorphous polyester.

In some embodiments, an amorphous polyester may be present in at least the shell. In some embodiments, the shell may comprise a first amorphous polyester and a second amorphous polyester, which may be present in equal amounts or non-equal amounts. In some embodiments, at least a crystalline polyester may be present in the core.

In core-shell toner particles, the at least one charge control agent may be present in the core, in the shell, or in both the core and the shell. In some examples, the core-shell toner particles may have a higher concentration of the at least one charge control agent in the shell than in the core. In some examples, the at least one charge control agent may be localized within the shell of the core-shell toner particles. That is, the core of the core-shell toner particles may lack the at least one charge control agent. When the at least one charge control agent is localized within the shell, the at least one charge control agent may be more effective at rendering the toner particles positively chargeable, as compared to that present in within the core. Therefore, localizing the at least one charge control agent within the shell of core-shell toner particles may allow more efficient use thereof to be realized.

Within the shell, the at least one charge control agent may be present in an amount ranging from about 0.1 wt % to about 10 wt %, or about 1 wt % to about 8 wt %, or about 2 wt % to about 5 wt %, based on total mass of the shell.

The toner particles of the present disclosure may be of any suitable shape, size, and morphology. For example, the toner particles may have a circularity, as determined by particle imaging, of about 0.96 to 1.0 or about 0.98 to about 1.0, including all values and subranges in between, such as about 0.97 to about 0.98 or about 0.98 to about 0.99. Preferably, the toner particles may have a D50 of about 5 microns to about 8 microns, including all values and subranges in between, such as about 6 microns to about 7 microns.

Toner particles containing at least one charge control agent in at least one location (e.g., within the shell) may further comprise internal additives, external additives, or any combination thereof. Internal additives may be blended within the polymer of the toner particles and are introduced during formation of the toner particles (e.g., during an EA toner process). Because internal additives are buried within the toner particles, they are believed to exert limited influence upon triboelectric chargeability. External additives, in contrast, may be blended with the toner particles after formation or isolation thereof, such that the external additives are located on the exterior (outer surface) of the toner particles or in the interstitial space between toner particles. Because external additives are outside the toner particles, they may exert a greater influence on triboelectric chargeability of finished toner compositions than do internal additives, such as colorants or other components. Internal or external additives that may be present include, but are not limited to, surfactants, colorants, waxes, charge additives, crosslinking agents, and other common materials present in EA toner particles. One having ordinary skill in the art will recognize illustrative types of such additives and suitable amounts to include during or after production of toner particles by an EA toner process.

One or more surfactants may be present in an emulsion used to form toner particles, such that the one or more surfactants become an internal additive in the toner particles after aggregation and coalescence takes place. Such surfactants may also be combined with the toner particles when forming a toner composition, in which case the one or more surfactants may be present as an external additive. Suitable surfactants may be nonionic, zwitterionic, anionic, or cationic. If the surfactant is ionic, the surfactant may be used to contribute to the overall charge of the toner composition. For example, a cationic surfactant may contribute to positive chargeability, and an anionic surfactant may decrease positive chargeability. When an anionic surfactant is present, the at least one charge control agent may counterbalance the negative chargeability promoted by the anionic surfactant.

One or more colorants, including dyes and pigments, may be present when forming toner particles, such that the one or more colorants become internal additives within the toner particles. Colorants may comprise a single colorant or two or more colorants. Suitable colorants may be present in the toner particles in an amount of about 0.1 wt % to about 35 wt %, or about 1 wt % to about 15 wt %, or about 3 wt % to about 10 wt %, based on total mass of the toner particles. Suitable colorants may include yellow colorants, magenta colorants, cyan colorants, black colorants, or any combination thereof and may be selected accordingly by persons having ordinary skill in the art. One or more waxes may be present during formation of the toner particles, such that the one or more waxes are present as an internal additive. A single wax or two or more waxes may be present. When present, the one or more waxes may adjust characteristics of the toner particles, such as shape, size, surface area, charging and/or fusing characteristics, gloss, stripping, offset properties, the like, or combinations thereof. The one or more waxes may be obtained or formulated as aqueous emulsions or dispersions of solid wax in water having a wax particle size in the range of about 100 nm to about 300 nm. The one or more waxes may be present in an amount ranging from about 1 wt % to about 20 wt %, including all values and subranges in between, based on total mass of the toner particles. Suitable waxes and amounts thereof will be familiar to one having ordinary skill in the art and may be selected accordingly.

One or more external additives may also be included in the toner compositions formed from the toner particles described herein. Suitable external additives may include, for example, flow aids, charge additives, and the like. Examples of the foregoing will be familiar to persons having ordinary skill in the art. Like internal additives, charged external additives may increase or decrease the triboelectric chargeability. When present, external additives may be present in an amount of about 0.1 wt % to about 10 wt %, including all values and subranges in between, based on total mass of a toner composition formed from the toner particles.

Suitable flow aids may include silica, titania, or other metal oxides, silicates, metal stearates, or any combination thereof. Silica (or titania) may include negatively charged silica (or titania) or positively charged silica (or titania), optionally with a hydrophobic or hydrophilic modification. Suitable examples of positively charged silica (or titania) may include, for example, amine-functionalized silica (or titania).

The toner particles may be prepared by any suitable method for forming the toner particles in a desired size and shape and are not particularly limited unless incompatible with the at least one charge control agent. In some examples, the toner particles of the present disclosure may be prepared by an emulsion-aggregation method. The emulsion aggregation methods described hereinbelow are intended to be illustrative in nature, and one having ordinary skill in the art may suitably modify other toner production techniques to realize the benefits described herein. Examples of emulsion-aggregation toner particle production methods that may be suitable to form toner particles for use herein may include, for instance, those described in U.S. Pat. Nos. 5,364,729, 5,496,676, 5,501,935, 5,919,595, 6,132,924, 6,495,302, 6,268,102, 6,500,597, 6,416,920, and 8,383,311 the disclosures of each of which are hereby incorporated by reference in their entirety.

In more specific examples, methods for producing positively chargeable toner particles and toner compositions may comprise: providing a polymer bearing a plurality of negatively charged functional groups and the at least one charge control agent is blended within the polymer; the at least one charge control agent comprising a cationic portion and an anionic portion, and the cationic portion forming an ionic association with at least a portion of the negatively charged functional groups and reducing an overall negative charge of the polymer; removing at least a portion of the anionic portion from the polymer; and processing the polymer to form toner particles in which the at least one charge control agent is present in at least one location within the toner particles.

The polymer may be previously blended with the at least one charge control agent and stockpiled prior to production of toner particles, or the at least one charge control agent may be integrated into the process for producing toner particles. When integrated within a process for producing toner particles, the at least one charge control agent may be blended with an emulsion of the anionic polymer, which is then subjected to emulsion aggregation and subsequent coalescence as described hereinafter. The anionic polymer may be dispersed as suspended particles in the continuous phase of the emulsion, and the at least one charge control agent may be dissolved in the continuous phase of the emulsion and/or dispersed as suspended particles in the continuous phase.

Processing the polymer to form toner particles may take place by emulsion aggregation methods (EA methods). The emulsion aggregation methods may take place in the presence of the at least one charge control agent.

Emulsion aggregation methods may take place by aggregating polymer particles contained within the continuous phase of an emulsion, optionally in the presence of other components (e.g., wax and/or colorants) that may become internal additives within the resulting toner particles.

The polymer particles may undergo aggregation with one another at a temperature below the glass transition temperature, optionally in the presence of the at least one charge control agent. Optionally, the at least one charge control agent may be omitted during forming the core of core-shell toner particles. After initial coalescence of polymer particles has taken place, a shell resin may be added to the coalesced polymer particles, such that core-shell particles form during the coalescence stage. The at least one charge control agent may be present in the shell resin, such that the at least one charge control agent is present within at least the shell following coalescence. During aggregation of the polymer particles, an aggregating agent may be present to promote aggregation. Suitable aggregating agents may include, but are not limited to, polyaluminum chloride (PAC), polyaluminum silicates such as polyaluminum sulfosilicate (PASS), or water-soluble salts such as aluminum chloride, aluminum nitrite, aluminum sulfate, potassium aluminum sulfate, calcium acetate, calcium chloride, calcium nitrite, calcium oxalate, calcium sulfate, magnesium acetate, magnesium nitrate, magnesium sulfate, zinc acetate, zinc nitrate, zinc sulfate, zinc chloride, zinc bromide, magnesium bromide, copper chloride, copper sulfate, or combinations thereof. When used, the aggregating agent may be combined with the emulsion below the glass transition temperature of the polymer.

When used, the aggregating agent may be combined with the polymer particles in any effective amount up to about 5 wt %, based on a mass of the polymer particles, such as about 0.2 wt % to about 1 wt % or about 0.5 wt % to about 1.5 wt %.

The polymer particles may be permitted to aggregate until a predetermined desired particle size is obtained. The particle size may be monitored during the growth process until the predetermined desired particle size is reached. The predetermined desired particle size refers to a target particle size to be obtained during aggregation, such that toner particles having a desired particle size are eventually obtained after coalescence is complete. The particle size is monitored during the growth process until the predetermined desired particle size is reached. Monitoring may take place using any of the particle size measurement techniques discussed herein. For example, samples may be taken during the growth process and analyzed, such as with a Coulter Counter, to determine the average particle size.

Depending on the glass transition temperature, aggregation may proceed at temperatures ranging from about 30° C. to about 100° C., or about 30° C. to about 80° C., or about 30° C. to about 50° C. The temperature may be held for a period of time from about 0.5 hours to about 6 hours, or about 1 hour to about 5 hours, during which time a desired aggregate size may form. Once a pre-determined aggregate size is reached, a shell resin may be added, and additional monitoring of the particle size may continue to take place. Before adding the shell resin, the particle size may range from about 1 μm to about 6 μm, including all values and subranges in between. The shell may be formed upon the aggregated polymer particles at the same temperature or a different temperature than that used for initially aggregating the polymer particles of the emulsion, again with the temperature being below the glass transition temperature. Formation of the shell may take place for a period of time from about 30 minutes to about 5 hours or about 1 hour to about 5 hours.

Once a desired size of the polymer particles is achieved, the pH may be adjusted to a value of about 7.1 to about 10. Adjustment of the pH may be utilized to freeze (stop) toner particle growth. The base utilized to stop particle growth may include an alkali metal hydroxide, ammonium hydroxide, or any combination thereof, for example. A chelating agent such as ethylenediamine tetraacetic acid (EDTA), for example, may also be added to help adjust the pH to the desired value.

After freezing growth of the polymer particles, the aggregated polymer particles may then be coalesced to a desired shape and circularity by heating above the glass transition temperature, such as at a temperature of about 70° C. to about 100° C., or about 80° C. to about 95° C., or about 90° C. to about 99° C. Heating may continue or the pH of the mixture may be adjusted (e.g., reduced) over a period of time until a desired circularity is reached. The period of time may range from about 1 hour to about 10 hours or from about 2 hours to about 4 hours. Various buffers may be used during coalescence. Following coalescence, the circularity may be about 0.95 or greater, or about 0.96 or greater, or about 0.97 or greater, or about 0.98 or greater, or about 0.99 or greater.

Optionally, an acid or acid-generating compound may be added to increase the rate of coalescence. Illustrative examples of suitable acids or acid-generating compounds may include, for example, acetic acid, nitric acid, ammonium persulfate, or the like. If an acid or acid-generating compound is added, the pH may remain at an alkaline pH value or reach neutrality. Ammonium persulfate may be particularly desirable, since this chemical may decompose at the temperatures used to promote coalescence, and release protons gradually to lower the pH.

After coalescence is complete, the toner particles may be cooled below the glass transition temperature for isolation of the toner particles. A suitable cooling process may include introducing cold water to a jacket around the reactor, for example. After cooling, the toner particles may be screened with a sieve of a desired size, filtered, washed with water, and then dried. Washing may remove all or a substantial portion of the anionic portion of the at least one charge control agent from the toner particles, while the cationic portion remains in ionic association with at least a portion of the negatively charged functional groups. Drying may be accomplished by any suitable process for drying including, for example, freeze-drying.

### Embodiments Disclosed Herein Include

Embodiment 1. A method comprising:
providing a polymer bearing a plurality of negatively charged functional groups, and at least one charge control agent is blended within the polymer;
   wherein the at least one charge control agent comprises a cationic portion and an anionic portion, the cationic portion forming an ionic association with at least a portion of the negatively charged functional groups and reducing an overall negative charge of the polymer;
removing at least a portion of the anionic portion from the polymer; and
processing the polymer to form toner particles;
   wherein the at least one charge control agent is present in at least one location within the toner particles.

Embodiment 2. The method of Embodiment 1, wherein the toner particles are core-shell toner particles.

Embodiment 3. The method of Embodiment 2, wherein the core-shell toner particles comprise a core surrounded by a shell, and the shell has a higher concentration of the at least one charge control agent than the core.

Embodiment 4. The method of Embodiment 3, wherein the at least one charge control agent is localized within the shell of the core-shell toner particles.

Embodiment 5. The method of any one of Embodiments 1-4, wherein the at least one charge control agent comprises a quaternary ammonium salt.

Embodiment 6. The method of Embodiment 5, wherein the quaternary ammonium salt comprises a quaternary ammonium cation and a sulfonate anion.

Embodiment 7. The method of any one of Embodiments 1-6, wherein the polymer comprises an anionic polyester.

Embodiment 8. The method of any one of Embodiments 1-7, further comprising:
combining one or more external additives with the toner particles.

Embodiment 9. The method of Embodiment 8, wherein the one or more external additives comprise one or more metal oxides.

Embodiment 10. The method of any one of Embodiments 1-9, wherein one or more internal additives are present when forming the toner particles and are located within the toner particles after formation thereof.

Embodiment 11. The method of Embodiment 10, wherein the one or more internal additives comprise at least one additive selected from the group consisting of a colorant, a wax, and any combination thereof.

Embodiment 12. A toner composition comprising:
toner particles comprising a polymer bearing a plurality of negatively charged functional groups; and
at least one charge control agent blended within the polymer;
   wherein the at least one charge control agent comprises a cationic portion and an anionic portion, the cationic portion forming an ionic association with at least a portion of the negatively charged functional groups and reducing an overall negative charge of the polymer; and
   wherein the at least one charge control agent is present in at least one location within the toner particles.

Embodiment 13. The toner composition of Embodiment 12, wherein the toner particles are core-shell toner particles.

Embodiment 14. The toner composition of Embodiment 13, wherein the core-shell toner particles comprise a core surrounded by a shell, and the shell has a higher concentration of the at least one charge control agent than the core.

Embodiment 15. The toner composition of Embodiment 14, wherein the at least one charge control agent is localized within the shell of the core-shell toner particles.

Embodiment 16. The toner composition of any one of Embodiments 12-15, wherein the at least one charge control agent comprises a quaternary ammonium salt.

Embodiment 17. The toner composition of Embodiment 16, wherein the quaternary ammonium salt comprises a quaternary ammonium cation and a sulfonate anion.

Embodiment 18. The toner composition of any one of Embodiments 12-17, wherein the polymer comprises an anionic polyester.

Embodiment 19. The toner composition of any one of Embodiments 12-18, further comprising:
one or more external additives.

Embodiment 20. The toner composition of Embodiment 19, wherein the one or more external additives comprise one or more metal oxides.

Embodiment 21. The toner composition of any one of Embodiments 12-20, further comprising:
one or more internal additives located within the toner particles.

Embodiment 22. The toner composition of Embodiment 21, wherein the one or more internal additives comprise at least one additive selected from the group consisting of a colorant, a wax, and any combination thereof.

To facilitate a better understanding of the embodiments of the present disclosure, the following examples of preferred or representative embodiments are given. In no way should the following examples be read to limit, or to define, the scope of the disclosure.

### Examples

D50 by volume was characterized using a Coulter Multisizer-3 instrument. Circularity was determined using an FPIA Sysmex3000 instrument. Glass transition temperature (T_{g}) and other thermal properties were determined employing differential scanning calorimetry (DSC) over a temperature range of 0-140° C. with a 10° C./minute ramping rate during heating and cooling. The glass transition temperature was measured using a TA Instruments® Q2000, using a 10 mg sample of toner.

Triboelectric charge was measured with a specially constructed blow-off type Faraday cage. A steel carrier consisting of irregularly shaped particles, with a weight median diameter of 120-160 μm (sieve screen method), was used. Known quantities of carrier and toner particles were used to provide a toner concentration of about 3 pph. The carrier and toner particles were weighed into a 120 mL glass jar. The jar was shaken for 10 minutes on a paint shaker at a frequency of 615 min-1. Charging results from an interaction of the two types of particles. A known weight of tribocharged developer was poured into the Faraday cage. When the charged toner is blown out of the cage, the cage becomes oppositely charged. The net charge on the cage at the end of this process was measured with an electrometer (Keithley 614), and the charge-to-mass ratio was calculated and reported as μc/g (microcoulombs per gram).

In the tables below, “tribo” means triboelectric charge.

The amount of charge control agent incorporated within the toner particles was measured by LC-MS. To perform the LC-MS analysis, about 0.1 g of toner particles were accurately weighed and combined with 5 mL of chloroform, followed by shaking for 1 hour. Methanol (15 mL) was then added. The samples were shaken for 30 minutes, and filtered through a 0.2 μm nylon filter. The filtrate was diluted 10-fold or 100-fold in methanol. The diluted filtrate solutions were processed on a 4.6×50 mm ZIRCHROM-PHASE 5 μm column at 400 μL/min using an isocratic mobile phase of 10% 10 mM ammonium acetate, 0.1% acetic acid in 3% acetonitrile and 90% 10 mM ammonium acetate, and 0.1% acetic acid in 50:50 acetonitrile: methanol on an ACCELA HIGH SPEED LC system interfaced to the Q-EXACTIVE mass spectrometer. Data were collected using positive and negative mode electrospray ionization (ESI) techniques. The positive ion at m/z 276.2679 was fragmented, and peak area of the resulting fragment ion at m/z 142.15 to 142.17 was used to determine the amount of positive ion of the charge control agent. For the negative ion of the charge control agent, the ion does not fragment significantly. Therefore, the area of the negative ion peak at m/z 222.990 to 223.02 was used to determine the amount of the negative ion of charge control agent. A methanol stock solution of benzyltributylammonium naphthalenesulfonate was used for calibration over a range of 0.01 to 2 μg/mL

General procedure for making polyester emulsion: An amorphous polyester emulsion was prepared using the following procedure. A blend of anionic polyester/methyl ethyl ketone (MEK)/isopropyl alcohol (IPA), and 10% aqueous ammonia (10.0 volumes: 5.0 volumes: 1.25 volumes: 30 volumes) was placed in a reactor, which was heated with a jacket set point of 60° C. A defoamer (700 ppm) was added incrementally to the reactor through a charging port. Once the reactor reached a temperature of 58° C., vacuum distillation was conducted to remove the solvent, after which the mixture was cooled to room temperature. The resulting aqueous emulsion had an average particle size of around 170 nm.

General procedure for making polyester emulsion containing charge control agent. An aqueous emulsion was prepared as above and then combined with benzyltributylammonium naphthalenesulfonate dissolved in methanol/ethanol. After mixing at 50° C. for 1 hour, the organic solvents were removed by vacuum distillation. The resulting latex had an average particle size of around 180 nm.

General Procedure for Emulsion Aggregation Production of Positively Chargeable Toner Particles. In a 2 L reactor, about 291 g of amorphous polyester emulsion (40 wt % polymer solids), either with or without benzyltributylammonium naphthalenesulfonate charge control agent, 42.5 g of crystalline polyester emulsion (40 wt % polymer solids), 89.8 g yellow pigment dispersion (18 wt % pigment particles, PY-74 pigment), and 76.8 g wax dispersion (30 wt % wax solids) were combined with about 715 g deionized water. The crystalline polyester emulsion was prepared as described in U.S. Patent Application Publication 2011/0177444. The pH of the mixture was adjusted to about 4.2 using 0.3 M nitric acid solution. Next, 4.48 g of aluminum sulfate solution (27.85 wt % aluminum sulfate) was added into the mixture and homogenized over a period of 5 minutes. The reactor was then heated at about 48° C. with stirring.

When the size of the polymer particles reached about 5.1 μm, 192 g of amorphous polyester emulsion (40 wt % polymer solids) containing about 3 pph of benzyltributylammonium naphthalenesulfonate charge control agent was introduced to the reactor. Heating was continued at 50° C. until the particle size reached 5.8 μm to 6.0 μm. The pH of the mixture was then adjusted to 5.0 using a 4% aqueous sodium hydroxide solution, followed by addition of 9.6 g of a solution of sodium ethylenediaminetetraacetic acid (40 wt % solids).

The pH was adjusted to 7.5, and the reactor was heated to the coalescence temperature of 85° C. Upon reaching the coalescence temperature, the pH was lowered to 7.1-7.5 with aqueous ammonium persulfate or nitric acid. After about 1.5 to 3.0 hours, the resulting toner particles possessed the desired circularity of about 0.970, and the temperature was cooled to below 45° C. using a heat exchanger. Upon cooling, the toner particles were washed with water to remove residual surfactants and charge control agent, and then dried to a moisture content below 1.2 wt %.

For producing finished toner compositions, the dried toner particles were combined with 1.2 pph amine-treated silica and 0.6 pph titanium dioxide and blended at 14,000 rpm for 60 seconds. The blending step was repeated 5 more times to form the finished toner compositions.

Tables 1A and 1B below summarize various parameters of toner particles and finished toner compositions produced according to the above procedures. All wt % values are measured relative to the total mass of the toner particles. A positively chargeable commercial toner composition is presented for comparison.

TABLE 1A

| | | | | | Amount of | |
|---|---|---|---|---|---|---|
| | | Measured | Measured | Amount of | Charge | |
| | | Amount of | Amount of | Charge | Control | |
| | | Charge | Charge | Control Agent | Agent in | |
| | | Control | Control | in Core | Shell | Amount |
| | Pigment | Cation | Anion | Emulsion | Emulsion | of Shell |
| Sample | Color | (wt %) | (wt %) | (wt %) | (wt %) | (wt %) |
| 1 | Yellow | 0.67 | <0.01 | 0 | 0.7 | 28 |
| 2 | Yellow | 0.67 | <0.01 | 0 | 0.8 | 32 |
| 3 | Yellow | 0.64 | <0.01 | 0 | 0.8 | 32 |
| 4 | Yellow | 0.55 | <0.01 | 0 | 0.7 | 28 |
| 5 | Magenta | 0.79 | <0.01 | 0 | 0.98 | 28 |
| 6 | Magenta | 0.72 | <0.01 | 0 | 0.84 | 28 |
| 7 | Magenta | 0.58 | <0.01 | 0 | 0.7 | 28 |
| 8 | Black | 0.88 | <0.01 | 0 | 0.96 | 32 |
| 9 | Cyan | 1.6 | nd | 1 | 1 | 28 |
| 10 | Cyan | 1.8 | nd | 1 | 1.4 | 28 |
| 11 | Cyan | 0.88 | <0.01 | 0 | 1 | 32 |
| Comp. | — | — | — | — | — | — |
| Ex. | | | | | | |

TABLE 1B

| | D₅₀ | | Tribo Charge-Toner | Tribo Charge-Toner |
|---|---|---|---|---|
| Sample | (μm) | Circularity | Particles (μC/g) | Composition (μC/g) |
| 1 | 6.09 | 0.976 | 19.12 | 14.86 |
| 2 | 6.13 | 0.981 | 34.85 | 16.33 |
| 3 | 6.05 | 0.969 | 22.61 | 17.38 |
| 4 | 6.14 | 0.965 | 22.26 | 20.31 |
| 5 | 6.27 | 0.972 | 17.47 | 12.83 |
| 6 | 6.07 | 0.971 | 15.49 | 12.99 |
| 7 | 5.93 | 0.973 | 21.40 | 15.82 |
| 8 | 5.96 | 0.971 | 16.73 | 14.43 |
| 9 | 6.1 | 0.970 | 17.91 | 13.91 |
| 10 | 5.98 | 0.976 | 12.96 | 4.36 |
| 11 | 6.00 | 0.972 | 20.08 | 13.97 |
| Comp. | — | — | — | 11.94 |
| Ex. | | | | |

As shown in Tables 1A and 1B, various factors may influence triboelectric chargeability. Such factors may include the amount of charge control agent that is present in the shell, the shell thickness (represented by a wt % of the shell), the particular pigment used, and the presence of silica or other external additives. Based on the LC-MS data, the quaternary ammonium cation of the charge control agent is held within the particles, whereas the sulfonate anion is lost during isolation and purification of the toner particles. As shown in Samples 9 and 10, the additional presence of charge control agent in the core does not significantly alter positive chargeability. No clear triboelectric chargeability trends were observed based on the shell thickness and the amount of charge control agent that was present in the shell. Finished toner compositions displayed lower triboelectric chargeability than did the parent toner particles.

Table 2 shows thermal properties of selected toner particles from above.

TABLE 2

| | First T_{g} | Second T_{g} | Peak Melt | |
|---|---|---|---|---|
| | Onset | Onset | Temperature | ΔH |
| Sample | (° C.) | (° C.) | (° C.) | (J/g) |
| 1 | 37.5 | 62.8 | 90 | 16.5 |
| 2 | 38.4 | 62.8 | 89.9 | 16.4 |
| 3 | 37.3 | 63.1 | 90.3 | 16.0 |
| 4 | 36.5 | 64.2 | 90.7 | 13.8 |
| 5 | 37.5 | 64.1 | 89.8 | 15.1 |
| 6 | 40 | 64.6 | 90 | 14.1 |
| 7 | 36.5 | 63.6 | 89.7 | 15.8 |
| 8 | 33.7 | 64.4 | 90.2 | 16.7 |
| 11 | 36.2 | 63.2 | 90.1 | 16.1 |

Flow characteristics of selected toner particles and commercial toners were determined using a Shimadzu Flowtester CFT500D instrument (1.0 mm ID die, 1.0 mm depth with recess on the bottom side. Softening point (Tₛ), flow-beginning temperature (T_{fb}) and viscosity Tin were all in a comparable range, as shown in Table 3. The viscosity T_{1/2} is determined by calculating the difference between the Sₘₐₓ and Sₘᵢₙ values from the flow curve and dividing the difference by 2.

TABLE 3

| | Ts | T_{fb} | T_{1/2} |
|---|---|---|---|
| Sample | (° C.) | (° C.) | (° C.) |
| 1 | 58.5 | 73.8 | 96.8 |
| 2 | 58.7 | 72.8 | 96.1 |
| 3 | 57.6 | 72.3 | 95.8 |
| 5 | 58.7 | 73.5 | 96.9 |
| 6 | 58.9 | 74.3 | 96.6 |
| 7 | 58.2 | 74.5 | 97.4 |
| Commercial | 60 | 74.2 | 96.2 |
| Magenta | | | |
| Toner | | | |
| Commercial | 60.6 | 72.9 | 95.5 |
| Yellow | | | |
| Toner | | | |

All documents described herein are incorporated by reference herein for purposes of all jurisdictions where such practice is allowed, including any priority documents and/or testing procedures to the extent they are not inconsistent with this text. As is apparent from the foregoing general description and the specific embodiments, while forms of the disclosure have been illustrated and described, various modifications can be made without departing from the spirit and scope of the disclosure. Accordingly, it is not intended that the disclosure be limited thereby. For example, the compositions described herein may be free of any component, or composition not expressly recited or disclosed herein. Any method may lack any step not recited or disclosed herein. Likewise, the term “comprising” is considered synonymous with the term “including.” Whenever a method, composition, element, or group of elements is preceded with the transitional phrase “comprising,” it is understood that we also contemplate the same composition or group of elements with transitional phrases “consisting essentially of,” “consisting of,” “selected from the group consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present invention. At the very least, and not as an attempt to limit the application of the doctrine of equivalents to the scope of the claim, each numerical parameter should at least be construed in light of the number of reported significant digits and by applying ordinary rounding techniques.

Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

One or more illustrative embodiments are presented herein. Not all features of a physical implementation are described or shown in this application for the sake of clarity. It is understood that in the development of a physical embodiment of the present disclosure, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for one of ordinary skill in the art and having benefit of this disclosure.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to one having ordinary skill in the art and having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The embodiments illustratively disclosed herein suitably may be practiced in the absence of any element that is not specifically disclosed herein and/or any optional element disclosed herein.

The invention claimed is:

1. A method comprising:
providing a polymer bearing a plurality of negatively charged functional groups, and at least one charge control agent is blended within the polymer;
wherein the at least one charge control agent comprises a cationic portion and an anionic portion, the cationic portion forming an ionic association with at least a portion of the negatively charged functional groups and reducing an overall negative charge of the polymer;
removing at least a portion of the anionic portion from the polymer; and
processing the polymer to form toner particles;
wherein the at least one charge control agent is present in at least one location within the toner particles.

2. The method of claim 1, wherein the toner particles are core-shell toner particles.

3. The method of claim 2, wherein the core-shell toner particles comprise a core surrounded by a shell, and the shell has a higher concentration of the at least one charge control agent than the core.

4. The method of claim 3, wherein the at least one charge control agent is localized within the shell of the core-shell toner particles.

5. The method of claim 1, wherein the at least one charge control agent comprises a quaternary ammonium salt.

6. The method of claim 5, wherein the quaternary ammonium salt comprises a quaternary ammonium cation and a sulfonate anion.

7. The method of claim 1, wherein the polymer comprises an anionic polyester.

8. The method of claim 1, further comprising:
combining one or more external additives with the toner particles.

9. The method of claim 8, wherein the one or more external additives comprise one or more metal oxides.

10. A toner composition comprising:
toner particles comprising a polymer bearing a plurality of negatively charged functional groups; and
at least one charge control agent blended within the polymer;
wherein the at least one charge control agent comprises a cationic portion and an anionic portion, the cationic portion forming an ionic association with at least a portion of the negatively charged functional groups and reducing an overall negative charge of the polymer; and
wherein the at least one charge control agent is present in at least one location within the toner particles.

11. The toner composition of claim 10, wherein the toner particles are core-shell toner particles.

12. The toner composition of claim 11, wherein the core-shell toner particles comprise a core surrounded by a shell, and the shell has a higher concentration of the at least one charge control agent than the core.

13. The toner composition of claim 12, wherein the at least one charge control agent is localized within the shell of the core-shell toner particles.

14. The toner composition of claim 10, wherein the at least one charge control agent comprises a quaternary ammonium salt.

15. The toner composition of claim 14, wherein the quaternary ammonium salt comprises a quaternary ammonium cation and a sulfonate anion.

16. The toner composition of claim 10, wherein the polymer comprises an anionic polyester.

17. The toner composition of claim 10, further comprising:
one or more external additives.

18. The toner composition of claim 17, wherein the one or more external additives comprise one or more metal oxides.

19. The toner composition of claim 10, further comprising:
one or more internal additives located within the toner particles.

20. The toner composition of claim 19, wherein the one or more internal additives comprise at least one additive selected from the group consisting of a colorant, a wax, and any combination thereof.
